(19) United States
(12) Patent Application Publication
(10) Pub. No.: US 2009/0237630 A1
(43) Pub. Date: Sep. 24, 2009

(54) Open-closed structure applied to a lamp door of a projector

(75) Inventors: Meng-Chu Hung, Hsin-chu (TW); Kuan-Chou Ko, Hsin-chu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsin-Chu (TW)

(21) Appl. No.: 12/379,560

(22) Filed: Feb. 25, 2009

(30) Foreign Application Priority Data
Mar. 21, 2008 (TW) 097110131

(51) Int. Cl. G03B 21/20

(52) U.S. Cl. 353/119

(57) ABSTRACT

An open-closed structure is used to open or close a lamp door of a projector. The projector includes a main lid. The lamp door covers the outer side of the main lid. The open-closed structure includes a base and a knob. The base is disposed at the inner side of the main lid. The knob is rotatably disposed on the base, and has an axial portion, a hook portion and a stick-like portion. One end of the hook portion is connected to the axial portion, and another end of that is selectively engaged with or separated from the lamp door. One end of the stick-like portion is also connected to the axial portion. When the axial portion of the knob is rotated to make the another end of the hook portion separated from the lamp door, another end of the stick-like portion is dependently moved to push the lamp door.

### BACKGROUND OF THE INVENTION

(1) Field of the Invention

The present invention relates to an open-closed structure, particularly to an open-closed structure applied to a lamp door of a projector.

(2) Description of the Prior Art

As usual, the housing of a projector has an aperture for changing the lamp. At present, the position of the aperture is disposed at the bottom of the projector generally. The lamp door for covering the aperture is fixed by screwing.

Referring to FIG. 1, a conventional projector 100 has a lamp door 120 located at the bottom thereof. For convenience in illustration, the bottom of the projector 100 faces upward in FIG. 1. The lamp door 120 is fixed on a housing 160 by a plurality of screws 140. When users want to change the lamp (not shown), a screwdriver is needed to release the screws 140, and then the lamp door 120 is prized.

However, whether the projector 100 is desktop type or ceiling-mount type, the lamp door 120 is at the bottom of the projector 100, so it is inconvenient to open the lamp door 120 due to placing the projector 100 upside down as shown in FIG. 1 or dismounting the projector 100 from the ceiling before changing the lamp.

For more convenient to change the lamp, the relevant structure of the projector is altered and changed to be disposed at the top thereof gradually.

Referring to FIG. 2, a conventional projector 200 has a lamp door 220 located at the top thereof. The lamp door 220 is locked on a housing 260 with a plurality of screws 240. For elegant appearance of the projector 200, when the lamp door 220 is closed, the outer surface 222 of the lamp door 220 is level with the surface 262 of the housing 260. Still, the screw 240 needs to be released before prizing the lamp door 220.

Accordingly, in the development of the projector 100, 200, the opening or closing manner of the lamp door 120, 220 needs to be improved.

### SUMMARY OF THE INVENTION

The invention is to provide an open-closed structure applied to a lamp door of a projector for opening the lamp door conveniently.

For one or part of or all objectives mentioned or other objectives, one embodiment of the present invention provides an open-closed structure applied to a lamp door of a projector. The projector includes a main lid and a lamp door covering one side of the main lid. The open-closed structure includes a base and a knob. The base is disposed at another side of the main lid. The knob is rotatably disposed on the base, and has an axial portion, a hook portion and a stick-like portion. One end of the hook portion and one end of the stick-like portion are respectively connected to the axial portion. Another end of the hook portion is selectively engaged with or separated from the lamp door. When the axial portion of the knob is rotated to make the another end of the hook portion to be separated from the lamp door, another end of the stick-like portion is dependently moved to push the lamp door.

Another embodiment of the present invention is a cover of a projector. The cover includes a main lid, a lamp door and above open-closed structure. The main lid has an outer side, an inner side and a through-hole. The outer side is relative to the inner side. The through-hole is near the edge of the main lid and goes through the outer side and the inner side. The lamp door is disposed at the outer side of the main lid to cover the through-hole. The open-closed structure is disposed at the inner side of the main lid. The base of the open-closed structure is connected to the main lid and near the perimeter of the through-hole. The knob is as above. When the axial portion of the knob is rotated to make the another end of the hook portion separate from the lamp door, another end of the stick-like portion is dependently moved to penetrate the through-hole for pushing the lamp door.

In the cover as above, the axial portion is a column with two end faces and a flank. The flank of the axial portion has a first trough and a second trough. The axial portion has a driving portion in one of the end faces thereof to rotate the axial portion. The one end of the hook portion and the one end of the stick-like portion are connected to the flank of the axial portion respectively. The first trough and the second trough are disposed on the flank of the axial portion. The hook portion, the stick-like portion, the first trough and the second trough take the axial portion as center, and are arranged in ring.

The open-closed structure further includes a fixed facility to fix the position of the axial portion of the knob. The fixed facility has a flexible part which has a fixed end and a free end. The fixed facility includes a location block which protrudes from the free end of the flexible part. The location block is inserted into the first trough or the second trough of the axial portion of the knob selectively. Besides, The fixed facility further has a trench, the fixed end of the flexible part is connected to an outside of the trench, and the location block is disposed at an inside of the trench.

In addition, the knob further includes a strengthening rib, one end of the strengthening rib is connected to the axial portion, and another end of the 5 strengthening rib is connected to the stick-like portion.

In conclusion, the open-closed structure in the embodiment of the present invention uses the knob and the axial portion thereof to open the lamp door of the projector. Moreover, the open-closed structure is disposed at the side of the cover of the projector to reduce the design limiting factors of the lo housing of the projector, and for the users to lift the cover of the projector conveniently.

Other objectives, features and advantages of the present invention will be further understood from the further technological features disclosed by the embodiments of the present invention wherein there are shown and 15 described preferred embodiments of this invention, simply by way of illustration of modes best suited to carry out the invention.

### BRIEF DESCRIPTION OF THE DRAWINGS

The present invention will now be specified with reference to its 20 preferred embodiment illustrated in the drawings, in which

FIG. 1 is a schematic view of a conventional projector and a lamp door thereof.

FIG. 2 is a schematic view of another conventional projector and a lamp door thereof.

FIGS. 3A and 3B are schematic views showing an embodiment of a projector and the open-closed structure of a cover thereof according to the present invention.

FIG. 4 is a schematic view showing an embodiment of the cover of the projector according to the present invention.

FIGS. 5A and 5B are schematic views showing an embodiment of a knob according to the present invention.

FIGS. 6A and 6B are schematic views showing an embodiment of a fixed facility according to the present invention.

FIG. 7 is a schematic view showing an embodiment of the cover of the projector and open-closed structure of the cover according to the present invention.

FIGS. 8A and 8B are the schematic views showing an embodiment of a knob according to the present invention.

FIG. 9 is a schematic view showing an embodiment of the cover of the projector according to the present invention.

FIGS. 10A and 10B are schematic views showing an embodiment of a fixed facility according to the present invention.

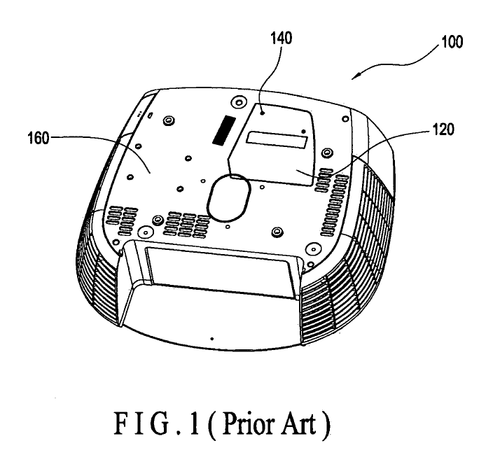

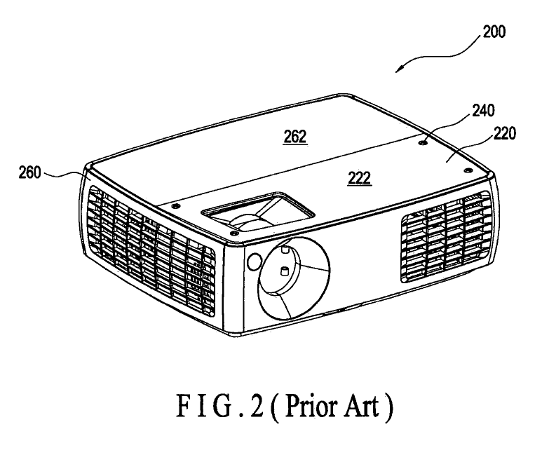

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front, ” “back,” etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

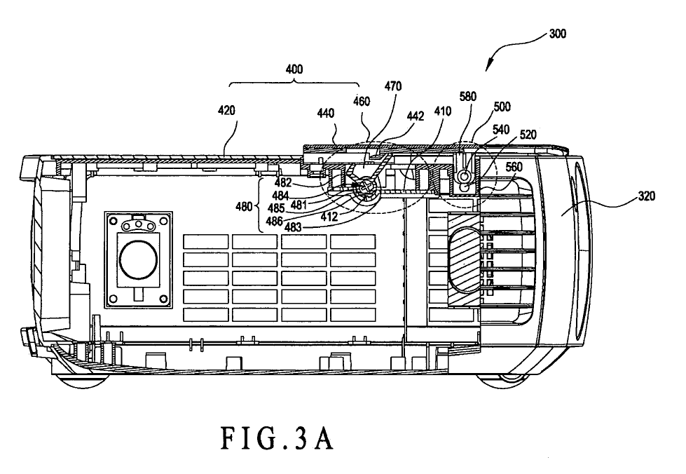

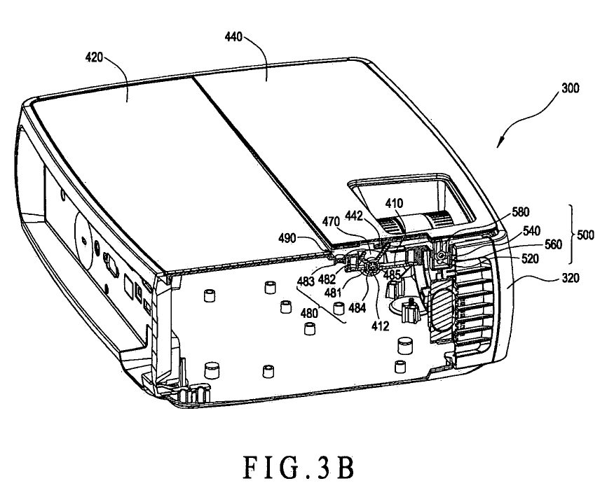

Referring to FIGS. 3A and 3B, a projector 300 includes an illumination element(not shown), a housing 320 and a cover 400. The housing 320 may hold the illumination element inside. The cover 400 is disposed on the housing 320, covers the inner space of the housing 320, and includes a main lid 420, a lamp door 440 and an open-closed structure 460 (in the broken line).

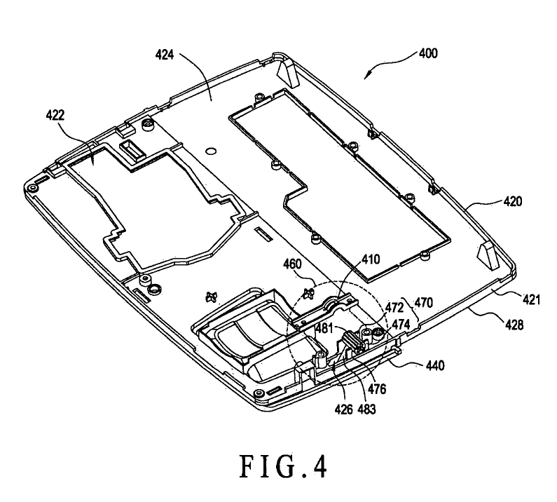

Refer to FIG. 4 for the cover 400 of the projector 300 in FIGS. 3A and 3B. For convenience, the inner side of the cover 400 is turned upwards. The main lid 420 of the cover 400 has a lamp aperture 422, an outer side 428, an inner side 424 and a through-hole 426. The lamp aperture 422 is disposed corresponding to the illumination element of the projector 300. The outer side 428 is relative to the inner side 424. The through-hole 426 is near the edge 421 of the main lid 420, and goes through the outer side 428 and the inner side 424. The lamp door 440 covers the outer side 428 of the main lid 420, so as to cover the through-hole 426 and the lamp aperture 422. The open-closed structure 460 is disposed at the inner side 424 of the main lid 420 to control the open and close of the lamp door 440.

Referring to FIGS. 3A and 3B, the open-closed structure 460 includes a base 470 and a knob 480, assembled at the inner side 424 of the main lid 420. The base 470 is connected at the inner side 424 of the main lid 420. The knob 480 has an axial portion 481, a hook portion 482 and a stick-like portion 483. One end of the hook portion 482 and one end of the stick-portion 483 are respectively connected to the axial portion 481. Another end of the hook portion 482 is selectively engaged with or separated from the lamp door 440.

Referring to FIG. 4, the base 470 is near the perimeter of the through-hole 426. The base 470 includes two brackets 472 and 474, disposed at the two opposite sides of the through-hole 426 respectively. Each of the brackets 472, 474 has an arc gap 476 to support the axial portion 481. After the axial portion 481 of the knob 480 is placed on the base 470, a fixed facility 410 is used to fix the position of the axial portion 481 of the knob 480. The fixed facility 410 is locked to the inner side 424 of the main lid 420 to prevent the axial portion 481 from detaching from the base 470.

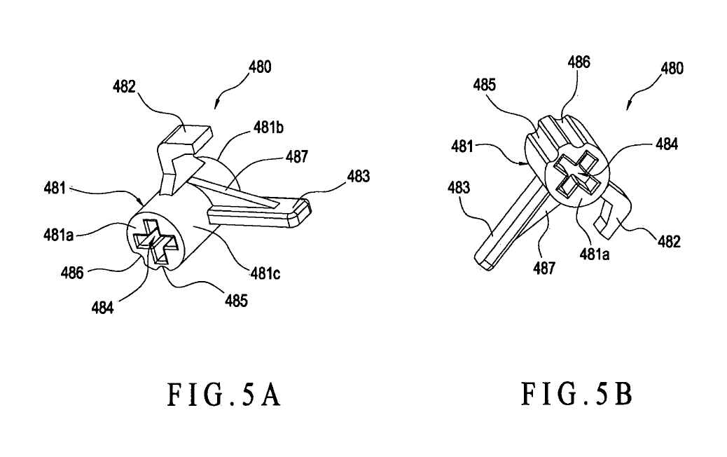

Referring to FIGS. 5A and 5B, the axial portion 481 of the knob 480, for example, is a column with two end faces 481a, 481b and a flank 481c. The end face 481 a has a driving portion 484. In the embodiment, the driving portion 484 is a groove for the insert of the cross, beeline-shaped or other suitable screwdrivers (not shown) to rotate the axial portion 481. In another embodiment, the driving portion 484 is a strip protrusion (not shown) for easy-holding to rotate the axial portion 481. When the axial portion 481 is rotated in the counter-clockwise direction, the other end of the stick-like portion 483 is dependently moved to push the lamp door 440 out to form a gap 490 in FIG. 3B, so that the user may open the lamp door 440 by hand.

In the embodiment, the hook portion 482 and the stick-like portion 483 are both connected to the flank 481c of the axial portion 481. There are a first trough 485 and a second trough 486 on the flank 481c of the axial portion 481, both in channel shape. Thus, the hook portion 482, the stick-like portion 483, the first trough 485 and the second trough 486 take the axial portion 481 as center, and are arranged in ring. Therefore, when the axial portion 481 is rotated, the hook portion 482, the stick-like portion 483, the first trough 485 and the second trough 486 are dependently moved. In addition, the knob 480 further includes a strengthening rib 487. One end of the strengthening rib 487 is connected to the axial portion 481, and another end thereof is connected to the stick-like portion 483 to support the stick-like portion 483.

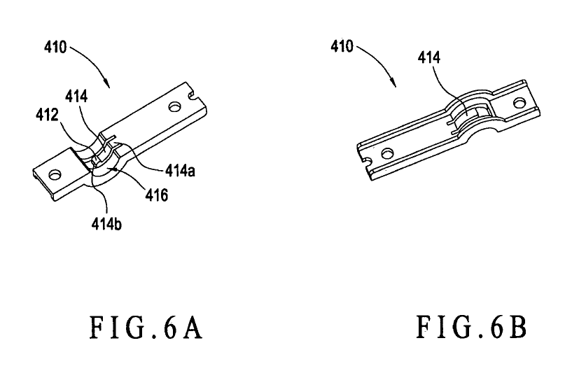

Referring to FIGS. 6A and 6B, the fixed facility 410 includes a location block 412. Referring to FIGS. 3A and 3B also, the location block 412 is inserted into the first trough 485 or the second trough 486 selectively.

The fixed facility 410 further has a flexible part 414 including a fixed end 414a and a free end 414b. The location block 412 is disposed on and protrudes from the free end 414b of the flexible part 414. In addition, the fixed facility 410 has a trench 416. The fixed end 414a of the flexible part 414 is connected to the outside of the trench 416, and the location block 412 is disposed at the inside of the trench 416. Moreover, in an embodiment (not shown), the fixed end 414a of the flexible part 414 is connected to the inside of the trench 416.

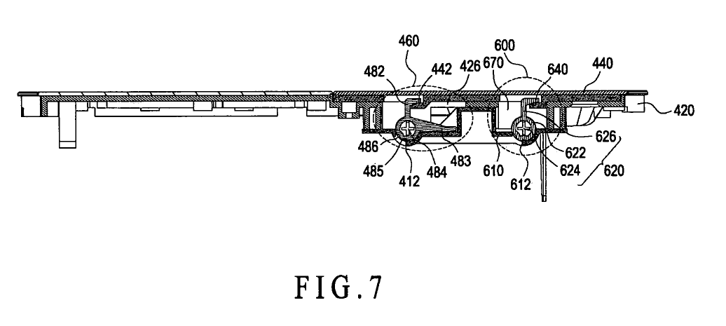

FIGS. 3A, 3B and FIG. 4 show that the hook portion 482 separated from the lamp door 440. FIG. 7 shows the hook portion 482 engaged with the lamp door 440. The hook portion 482 is a bending hook, and there is an inverted hook 442 on the inner side of the lamp door 440. Referring to FIG. 7, the hook portion 482 is engaged with the inverted hook 442 of the lamp door 440, so that the lamp door 440 is fixed at the outer side 428 of the main lid 420 and not easy to loose. Referring to FIGS. 3A, 3B and FIG. 4, when the axial portion 481 of the knob 480 is rotated to separate the hook portion 482 from the inverted hook 442 of the lamp door 440, the other end of the stick-like portion 483 goes through the through-hole 426 and further pushes the lamp door 440 at the outer side 428 of the main lid 420. The rotation of the knob 480 enforces the location block 412 to overcome the elastic force of the flexible part 414, and makes the free end 414b of the flexible part 414 to move down a little, so that the location block 412 separates easily from the first trough 485 and moves to the second trough 486. After that, the location block 412 is inserted in the second trough 486 because of the elastic force of the flexible part 414.

Basically, the open-closed structure 460 has the functions of opening, closing and fixing the lamp door 440. To avoid the lamp door 440 separating from the main lid 420 when covering it, besides the open-closed structure 460, a lock structure 500 is added on the cover 400 of the projector 300 to lock the lamp door 440 on the main lid 420. Or an engagement structure 600 is added to enhance the engagement of the lamp door 440 and the main lid 420.

Referring to FIGS. 3A, 3B and FIG. 4, the cover 400 of the projector 300 includes a lock structure 500 besides the open-closed structure 460. The lock structure 500 has a first screw hole 520 and a second screw hole 540. The first screw hole 520 is disposed in the main lid 420, and the second screw hole 540 is disposed in the lamp door 440. Noticeably, the first screw hole 520 is disposed in the trough 560 at the edge of the main lid 420; the second screw hole 540 is disposed in the lock piece 580 at the edge of the lamp door 440. When the lamp door 440 covers the main lid 420, the lock piece 580 is inserted into the trough 560 to make the first screw hole 520 aiming at the second screw hole 540 for a screw (not shown) to go through and lock up. Thus, the lock structure 500 has functions of combining the main lid 420 and the lamp door 440, and locating the lamp door 440.

Referring to FIG. 7, in another embodiment, the cover 400 of the projector 300 includes the engagement structure 600 besides the open-closed structure 460. The engagement structure 600 includes a knob 620 and an inverted hook 640. The knob 620 is disposed on the main lid 420, and the inverted hook 640 is disposed on the lamp door 440. In FIG. 7, the knob 620 includes an axial portion 622 and a bending hook 626. The axial portion 622 is placed on a base 670 and fixed by a fixed facility 610. When the lamp door 440 covers the main lid 420, the knob 620 is rotated to make the bending hook 626 to engage with the inverted hook 640 on the lamp door 440 to enhance the engagement.

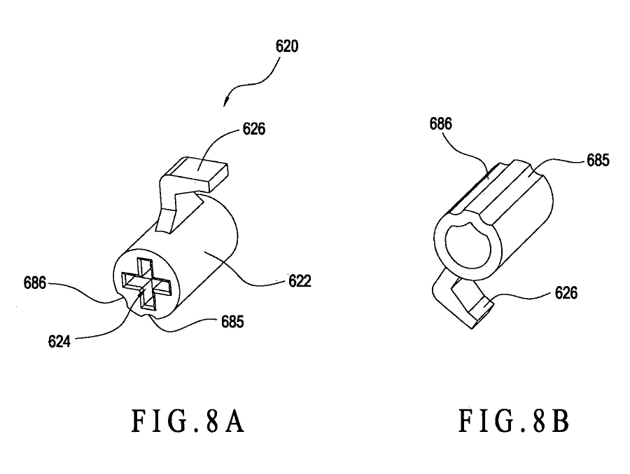

Referring to FIGS. 8A and 8B, compared with the knob 480, the knob 620 lacks the stick-like portion 483. The end face of the axial portion 622 has a driving portion 624. In the embodiment, the driving portion 624 is a groove for the insert of the cross, beeline-shaped or other suitable screwdrivers (not shown). In another embodiment, the driving portion 624 is a strip protrusion (not shown) for easy-holding. The axial portion 622 of the knob 620, for example, is a column with a first trough 685 and a second trough 686 on the flank thereof for the insert of the location block 612 on the fixed facility 610.

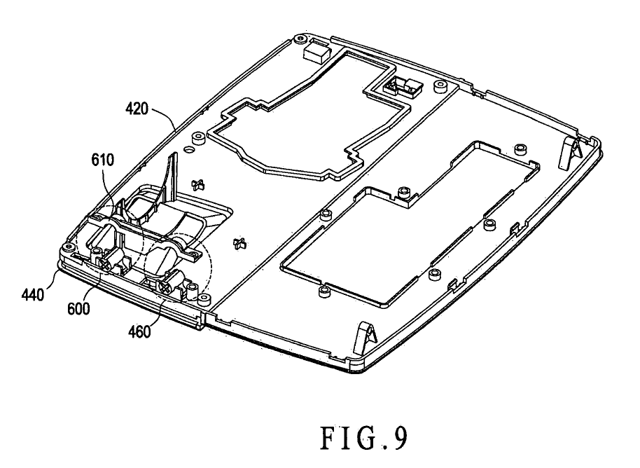

Referring to FIG. 9, in an embodiment, the engagement structure 600 is disposed at the edge of the main lid 420. The knob 620 and the knob 480 is disposed in parallel, so both of them are able to be fixed by the same fixed facility 610.

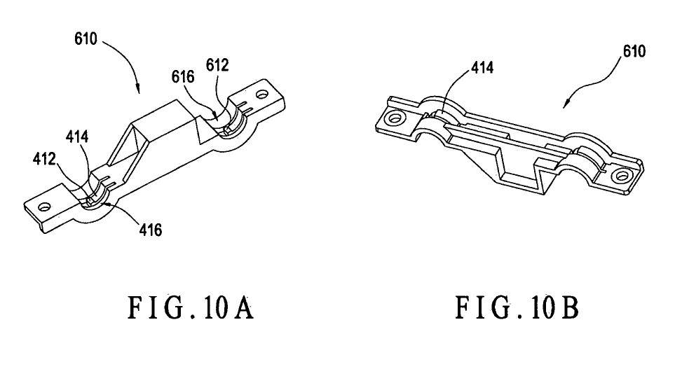

Referring to FIGS. 10A and 10B, compared with the fixed facility 410, the fixed facility 610 has a trench 616 and a location block 612 for matching the knob 620. The location block 612 is disposed on and protrudes from the part defining the trench 616 of the fixed facility 610, and is inside the trench 616. The location block 612 is made of flexible materials like plastic. The rotation of the knob 620 deforms the location block 612 to make it to separate from the first trough 685 more easily and move to the second trough 686. After moving to the second trough 686, the location block 612 recovers for inserting into the second trough 686.

In conclusion, the open-closed structure 460 in the embodiment of the present invention uses the knob 480 and the axial portion 483 thereof to open the lamp door 440 of the projector 300. Moreover, the open-closed structure 460 is disposed at the side of the cover 400 of the projector 300 to reduce the design limiting factors of the housing 320 of the projector 300, and for the users to lift the cover 400 of the projector 300 conveniently.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An open-closed structure, disposed on a projector, which comprises a main lid and a lamp door covering one side of the main lid, the open-closed structure comprising:
a base, disposed at another side of the main lid; and
a knob, rotatably disposed on the base, and having an axial portion, a hook portion and a stick-like portion, wherein one end of the hook portion and one end of the stick-like portion are respectively connected to the axial portion, another end of the hook portion is selectively engaged with or separated from the lamp door;
wherein when the axial portion of the knob is rotated to make the another end of the hook portion to be separated from the lamp door, another end of the stick-like portion is dependently moved to push the lamp door.

2. The open-closed structure of claim 1, wherein the axial portion has a first trough and a second trough.

3. The open-closed structure of claim 2, wherein the axial portion is a column with two end faces and a flank, the one end of the hook portion and the one end of the stick-like portion are connected to the flank of the axial portion respectively, the first trough and the second trough are disposed on the flank of the axial portion, and the hook portion, the stick-like portion, the first trough and the second trough take the axial portion as center, and are arranged in ring.

4. The open-closed structure of claim 3, wherein the axial portion has a driving portion in one of the end faces thereof to rotate the axial portion.

5. The open-closed structure of claim 2, further comprising a fixed facility to fix the position of the axial portion of the knob, wherein the fixed facility comprises a location block which is inserted into the first trough or the second trough of the axial portion of the knob selectively.

6. The open-closed structure of claim 5, wherein the fixed facility is locked to the another side of the main lid.

7. The open-closed structure of claim 6, wherein the fixed facility further has a flexible part, and the location block is disposed on the flexible part.

8. The open-closed structure of claim 7, wherein the flexible part has a fixed end and a free end, and the location block protrudes from the free end of the flexible part.

9. The open-closed structure of claim 8, wherein the fixed facility further has a trench, the fixed end of the flexible part is connected to an outside of the trench, and the location block is disposed at an inside of the trench.

10. The open-closed structure of claim 1, wherein the knob further comprises a strengthening rib, one end of the strengthening rib is connected to the axial portion, and another end of the strengthening rib is connected to the stick-like portion.

11. A cover of a projector, comprising:
a main lid having an outer side, an inner side and a through-hole, wherein the outer side is relative to the inner side and the through-hole goes through the outer side and the inner side;
a lamp door, disposed at the outer side of the main lid to cover the through-hole; and
an open-closed structure, disposed at the inner side of the main lid, comprising:
a base, connected to the main lid and near the perimeter of the through-hole; and
a knob, rotatably disposed on the base, having an axial portion, a hook portion and a stick-like portion, wherein one end of the hook portion and one end of the stick-like portion are respectively connected to the axial portion, another end of the hook portion is selectively engaged with or separated from the lamp door;
wherein when the axial portion of the knob is rotated to make the another end of the hook portion separate from the lamp door, another end of the stick-like portion is dependently moved to penetrate the through-hole for pushing the lamp door.

12. The cover of the projector of claim 11, wherein the axial portion has a first trough and a second trough.

13. The cover of the projector of claim 12, wherein the axial portion is a column with two end faces and a flank, the one end of the hook portion and the one end of the stick-like portion are connected to the flank of the axial portion respectively, the first trough and the second trough are disposed on the flank of the axial portion, and the hook portion, the stick-like portion, the first trough and the second trough take the axial portion as center, and are arranged in ring.

14. The cover of the projector of claim 13, wherein the axial portion has a driving portion in one of the end faces thereof to rotate the axial portion.

15. The cover of the projector of claim 12, further comprising a fixed facility to fix the position of the axial portion of the knob, wherein the fixed facility comprises a location block which is inserted into the first trough or the second trough of the axial portion of the knob selectively.

16. The cover of the projector of claim 15, wherein the fixed facility is locked to the inner side of the main lid.

17. The cover of the projector of claim 16, wherein the fixed facility further has a flexible part, and the location block is disposed on the flexible part.

18. The cover of the projector of claim 17, wherein the flexible part has a fixed end and a free end, and the location block protrudes from the free end of the flexible part.

19. The cover of the projector of claim 18, wherein the fixed facility further has a trench, the fixed end of the flexible part is connected to an outside of the trench, and the location block is disposed at an inside of the trench.

20. The cover of the projector of claim 11, wherein the knob further comprises a strengthening rib, one end of the strengthening rib is connected to the axial portion, and another end of the strengthening rib is connected to the stick-like portion.
